(19) United States
(12) Patent Application Publication
(10) Pub. No.: US 2014/0251890 A1
(43) Pub. Date: Sep. 11, 2014

(54) COLANDER-BOWL ASSEMBLY

(71) Applicant: UMBRA LLC, Buffalo, NY (US)

(72) Inventors: Helen T. Miller, Toronto (CA); Jordan Murphy, Toronto (CA)

(73) Assignee: Umbra LLC, Buffalo, NY (US)

(21) Appl. No.: 13/788,786

(22) Filed: Mar. 7, 2013

(51) Int. Cl. A47J 19/00

(52) U.S. Cl. CPC A47J 19/005
USPC 210/238; 210/469

(57) ABSTRACT

A colander-bowl assembly, having a bowl, the bowl having a rim and a first handle member extending outwardly from the rim, and, a colander pivotally secured to the bowl, the colander having a rim and also having a second handle member extending outwardly from the colander rim wherein said colander rotates exterior to said bowl.

### FIELD OF THE INVENTION

The invention relates generally to kitchen tools, more specifically to straining devices used in food preparation, and, even more specifically, a combination colander/bowl.

### BACKGROUND OF THE INVENTION

There are many types of sieves and strainers used in the kitchen that differ in shape, material, and permeability depending on the task at hand. A colander is a straining device used to drain pasta, store fruit because it keeps the fruit fresh for a longer period of time, rinse fresh produce or other such foods as pasta or freshly peeled boiled eggs, and can even aid in the cooking process itself. Colanders are such a basic kitchen tool that they can be found in almost every household.

Anyone who has cooked pasta is familiar with the same-old routine of placing the colander in the sink, carrying the pot of boiling water from the stove to the sink, carefully up-ending the pot full of scalding hot water into the colander, lifting the colander out of the sink while hopefully avoiding a face full of steam and burnt finger tips, dumping the remaining food from the colander into the pot or another suitable bowl for mixing or serving, and then scraping out any stragglers that have clung to the walls of the colander. The routine requires multiple transfers of food material and, therefore, increases the risk of running into problems such as dropping rogue food, food sticking to the bowl and/or the colander, and requiring the user to use extreme care and both hands, especially when dumping hot contents. Rogue food and liquid dripping or sloshing over the sides can be especially burdensome if the food materials are hard to get out of cloth or rugs, and can be especially dangerous by creating a slippery floor and unsanitary kitchen conditions. For these reasons, attempts have been made to combine a colander and bowl into one container assembly.

U.S. Patent Application Publication No. U.S. 2012/0055515 (de Raddo) describes one such combination assembly where the colander is inserted into the bowl and is removably attached at either the rim of the bowl or the base of the bowl by using a snap fit. The colander and the bowl are two independent devices that only work together with the foresight of the user to snap them together before preparation begins. Unfortunately, the user still has to completely remove the colander from the bowl to strain the food and then complete the further steps of emptying the bowl of water and emptying to colander back into the bowl. This leads to the familiar problem of dripping while the colander is being carried to or from a sink. Furthermore, the food material and liquids contained in this assembly are directly in contact with the colander while the user is trying to unsnap it from the bowl, thereby requiring the same heightened caution by the user in order not to spill.

Another combination kitchen apparatus is described in U.S. Pat. No. 5,957,038 (Shimazaki) which discloses a pot top that functions as a colander, steamer or strainer depending on its spatial orientation with respect to the pot. The pot and the strainer have mating handles such that, when used as a strainer, the user grasps the handles as if it were one. While this combination can be turned as one unit allowing for the straining and emptying to be done in one motion, the stability and control of the contained food is dependent upon the user's strength and coordination in holding the mating handles together. Also, the user is required to set up the apparatus in a specific way prior to use.

U.S. Pat. No. 7,537,130 (Lee et al.) discloses a colander stacked inside a bowl, where the bowl and colander are arranged to move from a nested stacked position to a position where the bowl and strainer are facing each other where the whole assembly can then be flipped in order to strain its contents. The bowl and colander are attached by a pair of linear attaching strips that each have an elongated aperture in it for receiving and maintaining a stud protruding from the bowl and a stud from the strainer. The width of the aperture is greater than the diameter of the rod members of the studs allowing the studs to slide within the attaching strip. The studs are diametrically opposed on both the bowl and the strainer. However, the colander still fully lines the inside bowl, which makes stirring of the contents difficult, as the stirring utensil must traverse the apertures of the colander. Moreover, the colander has a flat base to correspond with the flat base of the bowl when the colander and bowl are nested, so rotating the colander requires a flat surface to slide against the curved sides of the bowl.

U.S. Patent Application Publication No. U.S. 2012/0174798 (Kulikowski) provides a pivoting cooking pot by freely suspending the strainer on axles. While this allows for straining and emptying to be done in one motion, the strainer does not lock into place and the user will have to be cautious about any harmonic oscillations that result from trying to match the tipping rate of the pot with that of the colander rotation. Also, the user will still have the added step of dumping the remaining colander contents back into the bowl in order to prepare the food further because the cooking pot comprises two independent bowl and colander members.

U.S. Patent Application Publication No. U.S. 2006/0070944 discloses a strainer rotatably mounted to a cooking pot. The user holds a handle that is connected to the strainer and can press a tab connected to the pot in order to rotate the pot into a dumping position while the strainer maintains a generally horizontal position. Unfortunately, this container also has the characteristic that the pot is moving during the dumping motion and the user will have to be extremely cautious. Further, when initially pushing the tab to rotate, the force required to overcome static friction will be more than the force required to overcome kinetic friction so an increased risk of spilling occurs and is dependent upon the user's coordination and skill.

Therefore, there has been a long-felt need for a colander-bowl assembly having the colander pivotally attached to the exterior of the bowl. There is also a long felt need for a colander-bowl assembly that easily locks into a draining position and a bowl position.

### BRIEF SUMMARY OF THE INVENTION

The present invention broadly comprises a colander-bowl assembly, having a bowl, the bowl having a rim and a first handle member extending outwardly from the rim, and a colander pivotally secured to the bowl, the colander having a rim and also having a second handle member extending outwardly from the colander rim wherein said colander rotates exterior to said bowl.

A general object of the present invention is to provide a colander bowl assembly that allows the bowl to dispense of the unwanted elements and the colander to strain the contained material in the same motion. This is achieved by securing a colander to a bowl at an angular configuration such that when the bowl is tilted at an angle sufficient to strain out the unwanted elements of the contained material, the colander is in a generally horizontal position substantially similar to the bowl's pre-tilt position.

Another object of the present invention is to provide a colander bowl assembly that decreases the risk of spilling and sloshing liquid over the rims of either the bowl or colander. This object is achieved by securing the colander to the bowl such that the colander does not engage the contents of the bowl during the act of switching to an open position or a closed position.

A further object of the present invention is to provide a colander bowl assembly that increases the user's level of control over the situation while straining the contained material through the colander. This object is achieved by locking the colander in place in an open position so that the colander does not swing while the bowl is being tilted.

Still another object of the current invention is to provide a colander bowl assembly that can still be used as a strainer device even without the foresight of the user that they would need a strainer device. This is achieved by securing the colander to the bowl in such a way that the straining ability of the assembly is not conditional on the colander starting in a position between the contents of the bowl and the bowl.

Still a further object of the present invention is to provide a colander bowl assembly with the colander pivotally attached to the bowl.

These and other objects, advantages and features of the present invention will be better appreciated by those having ordinary skill in the art in view of the following detailed description of the invention in view of the drawings.

### BRIEF DESCRIPTION OF THE DRAWINGS

Further advantages and advantageous embodiments of the invention will become apparent from the Figures listed below and their descriptions.

FIG. 1 is a perspective view of a preferred embodiment of the invention;

FIG. 2 is an exploded view of the embodiment shown in FIG. 1;

FIG. 3 is a front view of the colander;

FIG. 3A is an enlarged view of the front detent pair on the colander shown in FIG. 3;

FIG. 4A is a fragmentary view of the front detent pair on the colander shown in FIG. 3 holding the bowl axle in the locking detent;

FIG. 4B shows the bowl axle in the process of moving from the locking detent to the transitioning detent, which is accomplished by flexing the pinch points;

FIG. 4C shows the bowl axle in the transitioning detent;

FIG. 5 is a fragmentary perspective view of the front axle mechanism of the bowl;

FIG. 6 is a right lateral view of the bowl;

FIG. 6A is an enlarged view of the axle mechanism shown in FIG. 6;

FIG. 7 is a fragmentary cross-sectional view of the axle mechanism taken generally along line 7-7 in FIG. 11;

FIG. 8 is a bottom view of the bowl;

FIG. 8A is an enlarged bottom view of the axle mechanism shown in FIG. 8;

FIG. 9 is an enlarged perspective view of the pivoting mechanism shown in FIG. 1;

FIG. 10A is a front view of the embodiment shown in FIG. 1 in a locked closed position;

FIG. 10B is a front view of the embodiment shown in FIG. 1 ready to transition into an open position;

FIG. 10C is a front view of the embodiment shown in FIG. 1 in an open position;

FIG. 10D is a front view of the embodiment shown in FIG. 1 in an open position ready to transition into an extended open position;

FIG. 10E is a front view of the embodiment shown in FIG. 1 in an extended open position;

FIG. 11 is a top view of the embodiment shown in FIG. 1;

FIG. 12A is a cross-sectional view of the embodiment shown in FIG. 11 taken generally along line 12A-12A in FIG. 11, where the colander is in the closed locked position and the axle of the bowl is in the locking detent;

FIG. 12B is a cross-sectional view of the embodiment shown in FIG. 11 taken generally along line 12B-12B in FIG. 11, where the colander is in the transitioning closed position and the axle of the bowl is in the transitioning detent;

FIG. 12C is a cross-sectional view of the embodiment shown in FIG. 11 taken generally along line 12C-12C in FIG. 11, where the colander is in the open position;

FIG. 13A is a fragmentary view showing a first bumper and slits on the colander;

FIG. 13B is a fragmentary view showing a second bumper with the first bumper and slits on the colander;

FIG. 14A illustrates an embodiment of the current invention being used in a closed position; and,

FIG. 14B illustrates an embodiment of the current invention being used in an open position.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. In regards to the current invention, contained material should be understood as any matter present that is either stably supported within the diameter of the assembly or is in a reasonable state of motion consistent with that of being strained through plurality of apertures 27. Although any methods, devices or materials similar or equivalent to those described herein can be used in the practice or testing of the invention, the preferred methods, devices, and materials are now described.

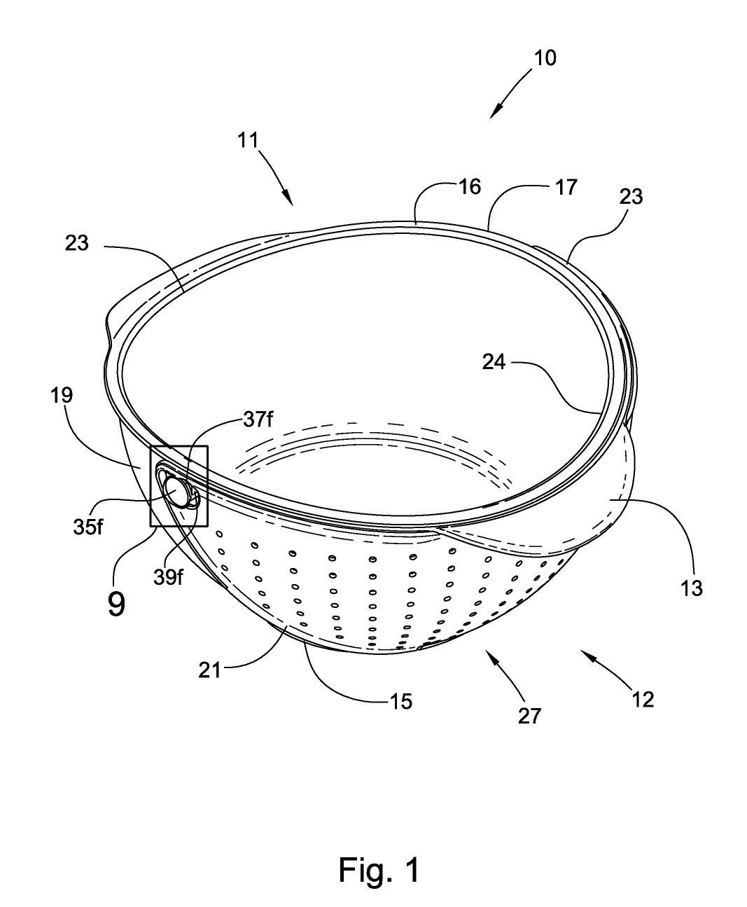

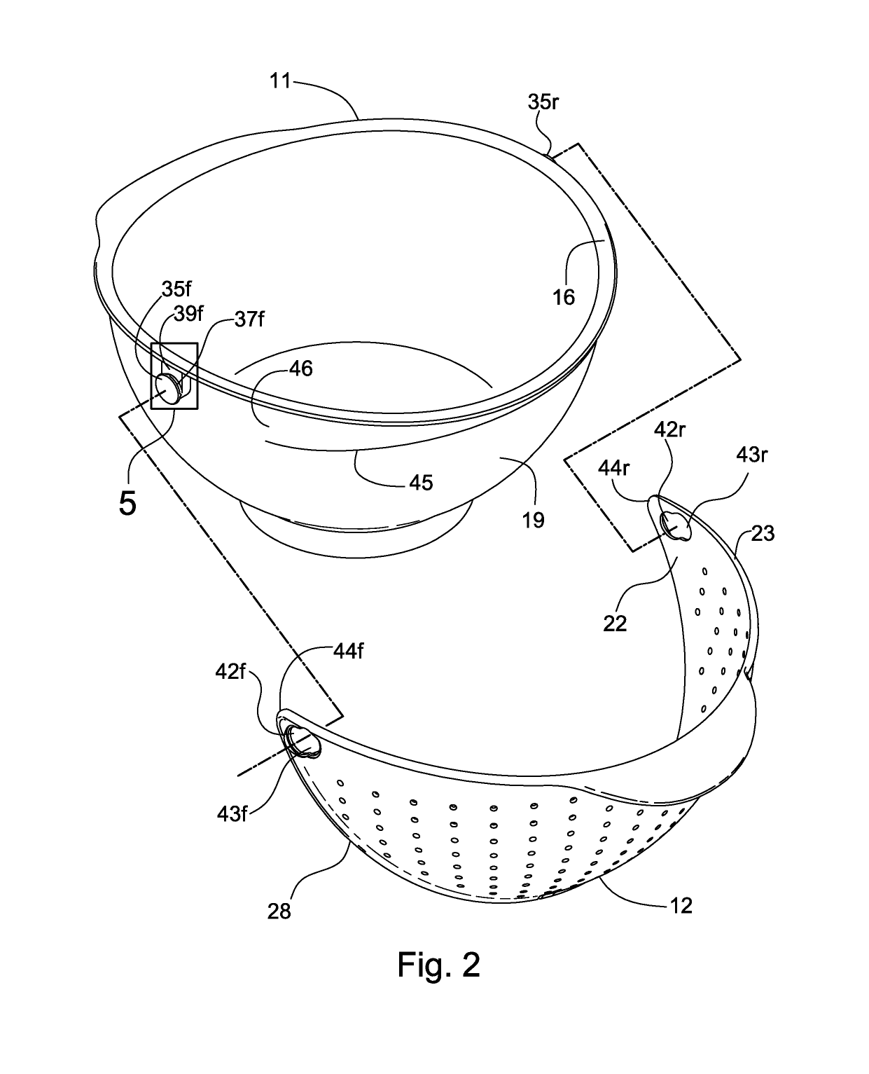

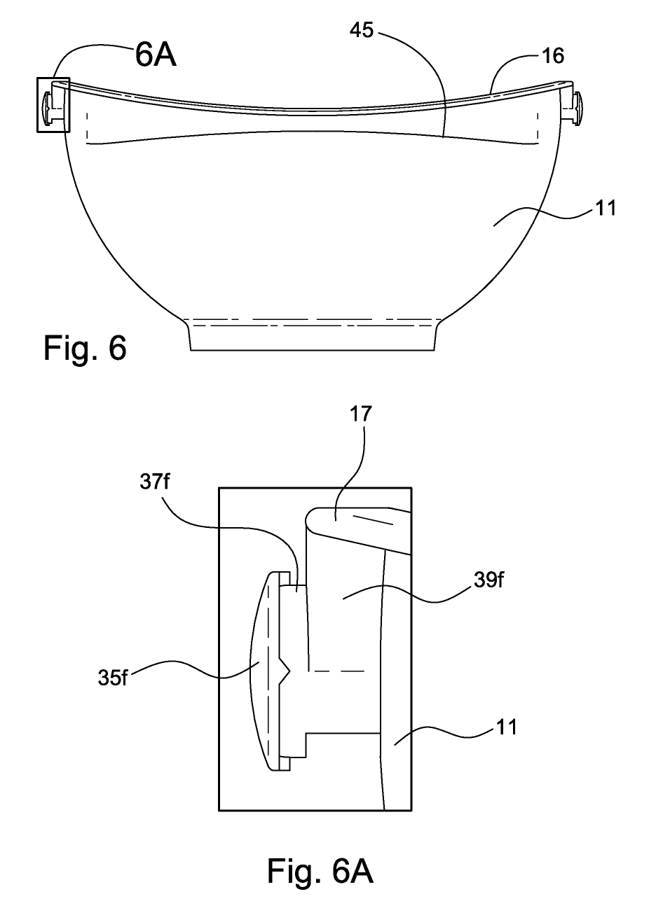

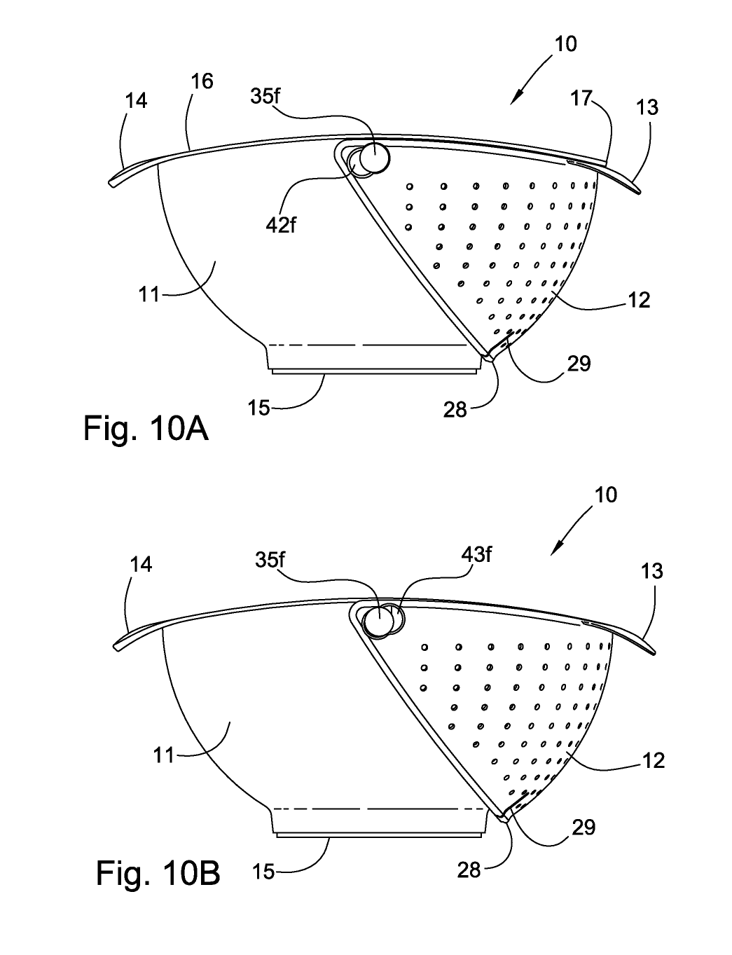

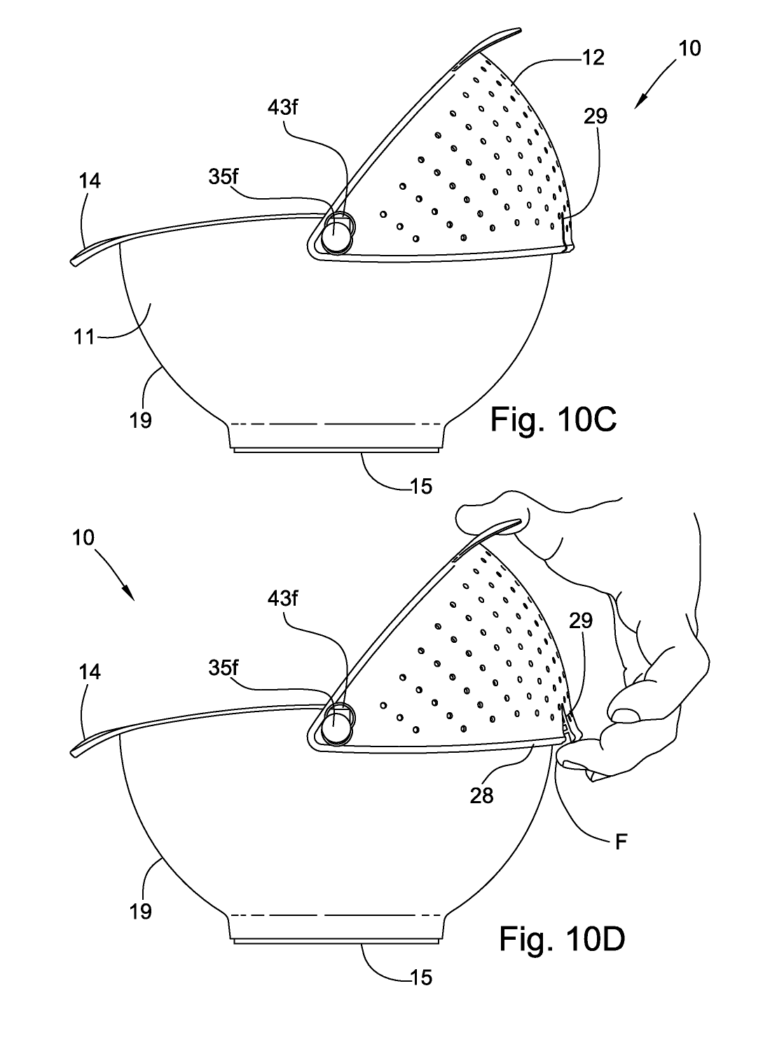

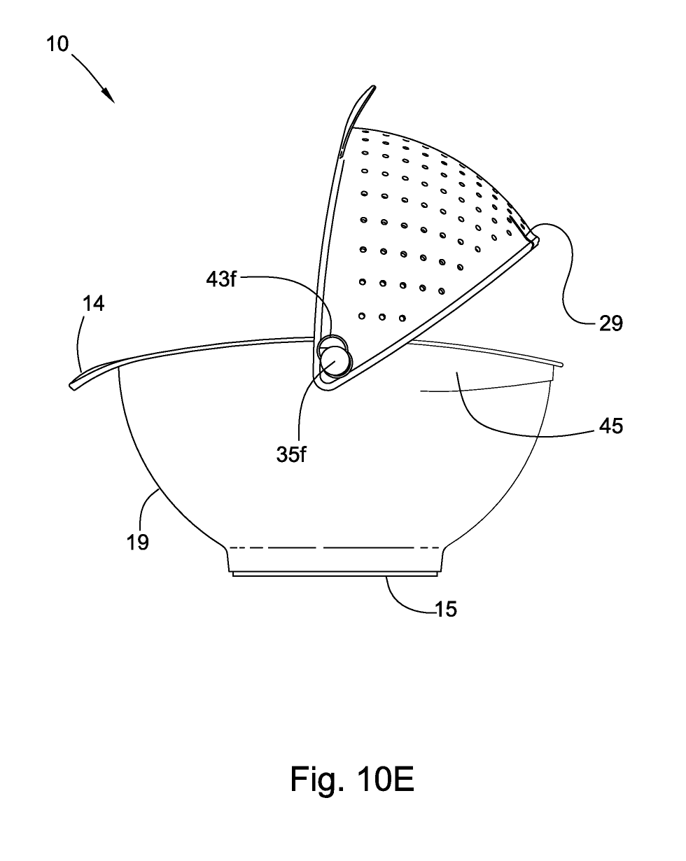

Referring now to the Figures, FIG. 1 is a perspective view of colander-bowl assembly 10 with colander 12 pivotally attached to bowl 11 at diametrically opposed heads 35f and 35r (shown in FIG. 2). Colander exterior wall 21 generally takes the shape of a spherical lune defined by a radius and a dihedral angle. Preferably, colander 12 is a hollow octosphere shape while bowl 11 can be a concave member having an open top end, or a hollow semi-sphere. (For purposes of this patent we define “octosphere” to mean one eighth of a sphere or having colander exterior wall 21 depicting a spherical lune with a dihedral angle of 45 degrees.) However, any shape combination allowing the smooth rotation of colander 12 suffices such that bowl exterior wall 19 is of a first shape, and colander 12 has an interior wall arranged to slidingly engage exterior wall 19, wherein the interior wall has a shape substantially similar to the first shape. Preferably, bowl 11 is a concave member having an open top end, but any known shapes for bowls are within the scope of this invention. In another embodiment, bowl 11 is substantially in the shape of a hollow semi-sphere. In a preferred embodiment, rim 16 creates a saddle contour by curving slightly downward in the lateral directions, as seen in FIG. 10A, and slightly upward in the front and back, as seen in FIG. 6. Bowl lip 17 is part of rim 16.

As seen in FIG. 2, heads 35f and 35r are fixed with respect to bowl 11, and detents 42f and 43f and 42r and 43r are configured to operatively engage heads 35f and 35r, respectively, such that colander 12 is pivotally secured to bowl exterior wall 19 and arranged to rotate exterior to bowl 11. Each pair of detents (42f and 43f; and 42r and 43r) are situated near colander vertices 44f and 44r and function together to allow rotation and locking of the colander in various positions relative to the bowl. Vertices 44f and 44r are formed from the conjunction of colander rim 23 and ridge 28. We first describe the structure and function of detent pair 42f and 43f, with an understanding that detent pair 42r and 43r is structured and function in exactly the same way.

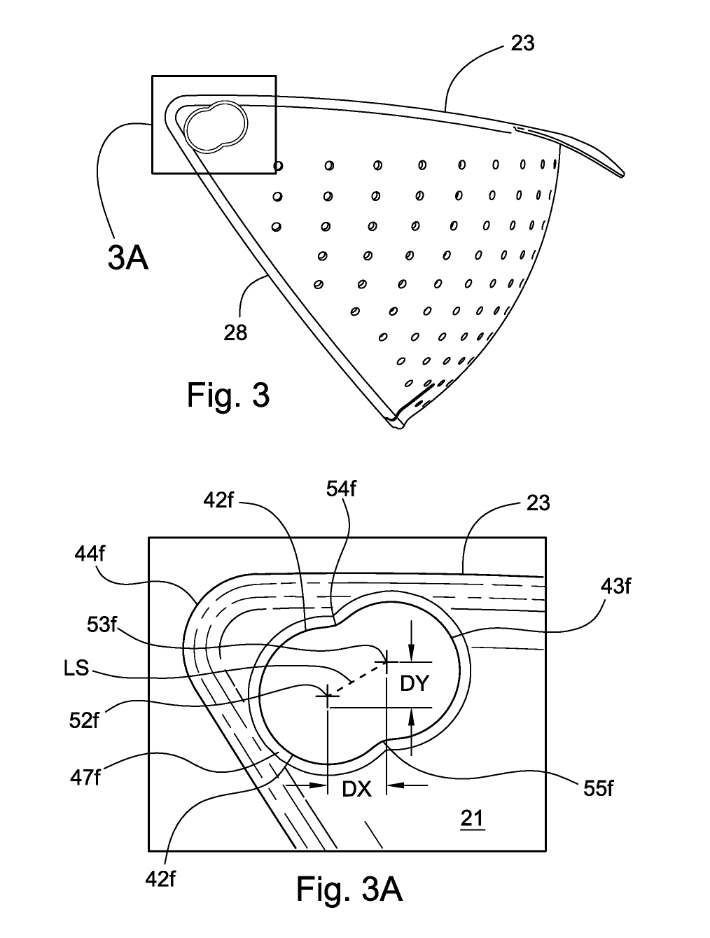

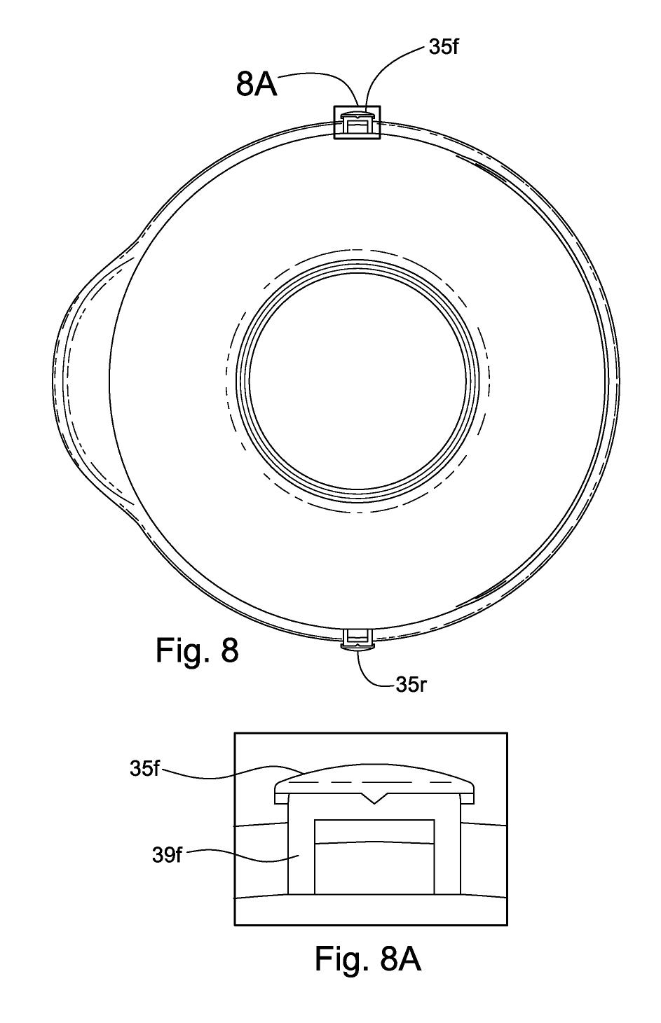

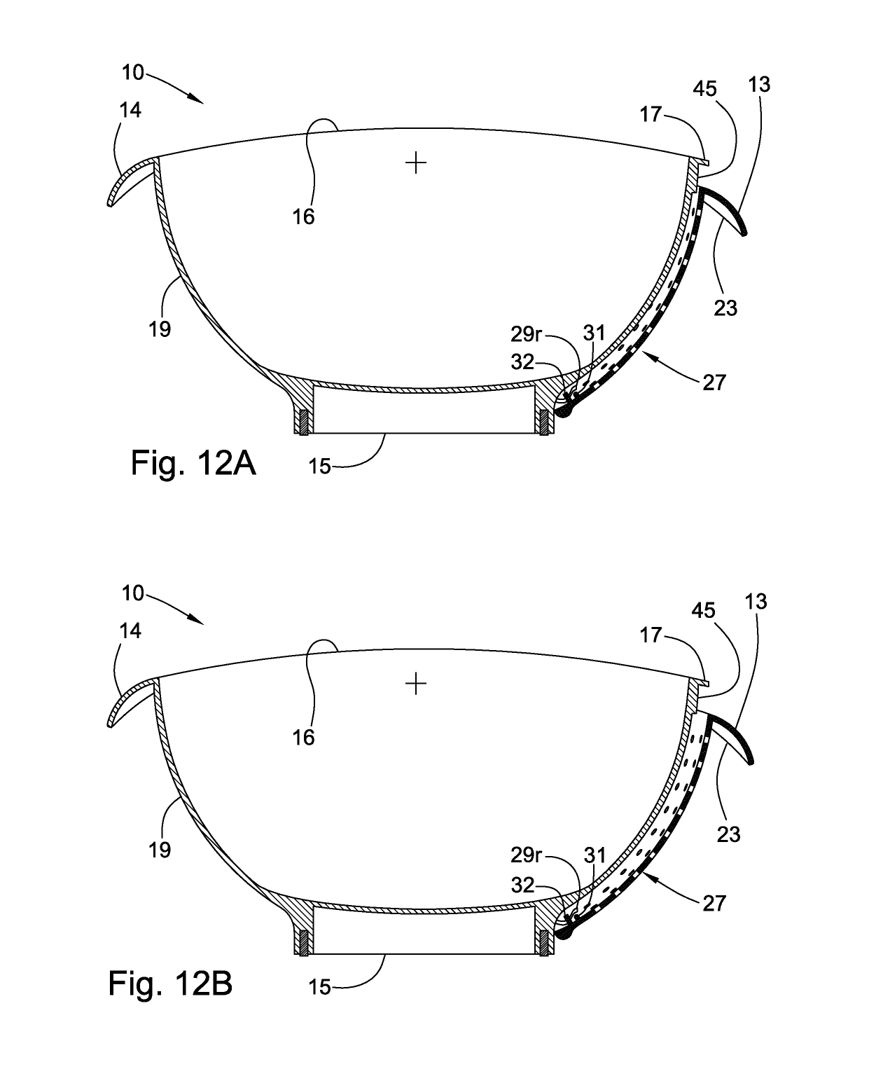

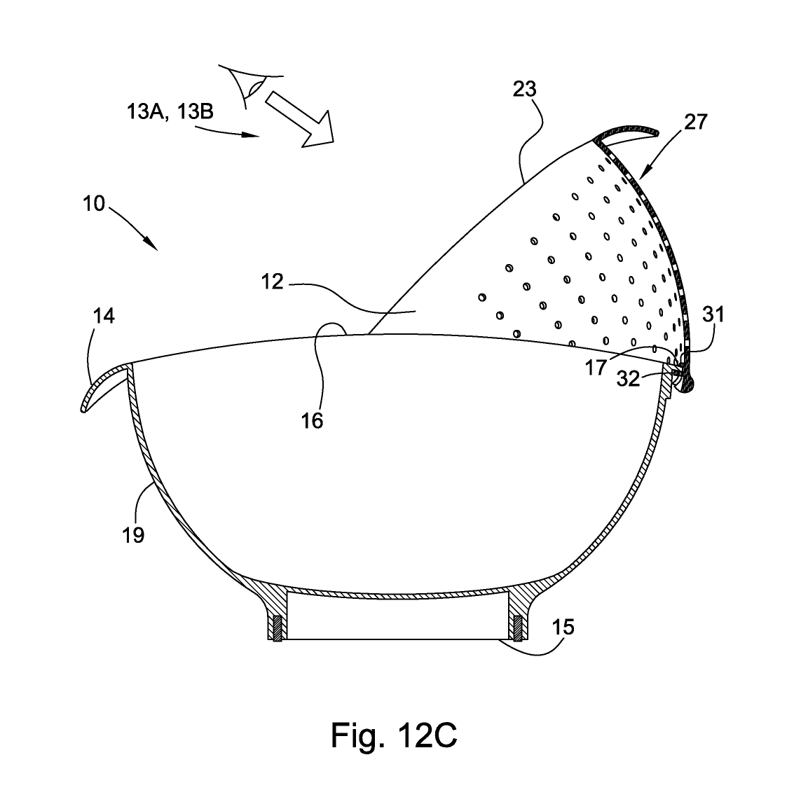

Referring now to FIGS. 3 and 3A, detents 42f and 43f are circular voids that are circumscribed with beveled surface 47f. Beveled surface 47f slopes from colander exterior wall 21 toward colander interior wall 22 (interior wall 22 is labeled in FIG. 2) as the radius of detents 42f and 43f decrease. A single void, in the shape of a “FIG. 8 [∞]” is created with the two pinch points 54f and 55f resulting at the intersection points between overlapping detents 42f and 43f. Center points 52f and 53f of transitioning detent 42f and locking detent 43f, respectively, create the end points of line segment LS. Preferably, center points 52f and 53f are displaced from one another such that displacement DY in the vertical direction and displacement DX in the horizontal direction create line segment LS with a positive slope with respect to rim 23. Displacement DX functions to increase or decrease the radius of the spherical lune created by colander exterior wall 21. A larger spherical lune radius results in a gap between colander 12 and bowl 11, which facilitates the pivoting motion. For this reason, transitioning detent 42f is positioned closer to vertex 44f in the DX direction. The gap is best seen in FIG. 12B between colander rim 23 and linear protrusion 45. A smaller spherical lune radius provides a snug fit between colander rim 23 and linear protrusion 45 of bowl 11, as can be seen in FIG. 12A.

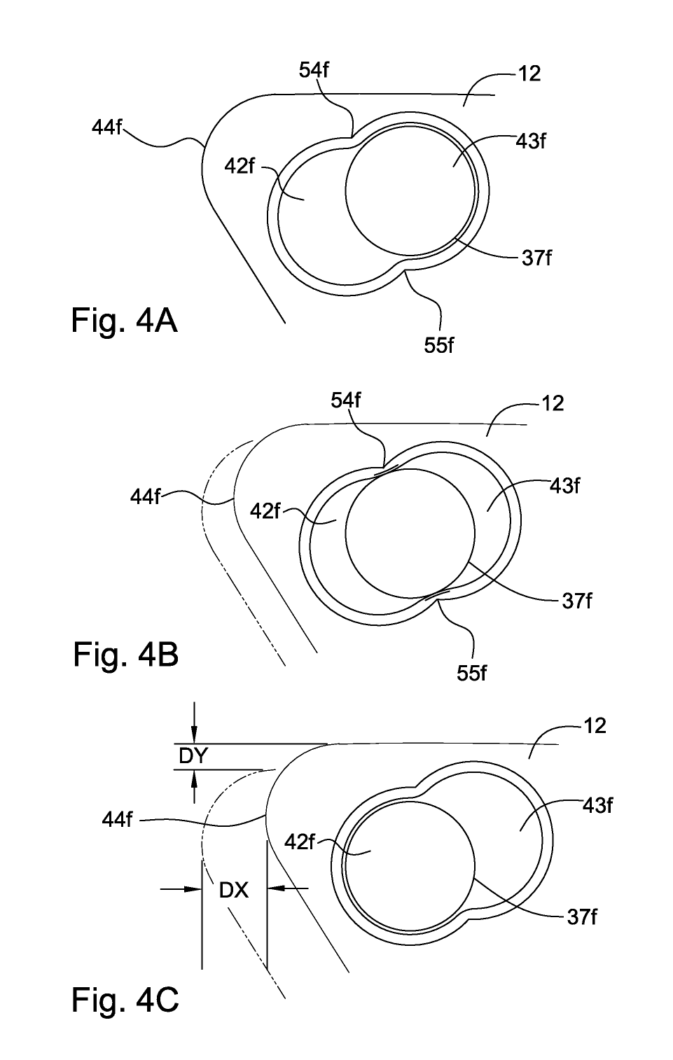

FIGS. 4A-C show axle 37f, with head 35f removed, engaging the “FIG. 8 [∞]” shaped void created by detents 42f and 43f at different stages of transition. The diameter of axle 37f is larger than the distance between pinch points 54f and 55f in order to keep axle 37f from transitioning without an affirmative action by the user. FIG. 4A shows axle 37f positioned in locking detent 43f. FIG. 4B shows axle 37f in between locking detent 43f and transitioning detent 42f with vertex 44f displaced from its position in FIG. 4A. In this position, pinch points 54f and 55f are flexed or distorted to allow axle 37f to pass through. FIG. 4C shows axle 37f positioned in transitioning detent 42f with vertex 44f displaced from its position in FIG. 4A by DX in the horizontal direction and DY in the vertical direction. In this position, pinch points 54f and 55f return to their original undistorted state like in FIG. 4A in order to keep axle 37f from transitioning without an affirmative action by the user. To accommodate for the distortion and reversion back to its original state, colander 12 is preferably made from a resilient material such as plastic.

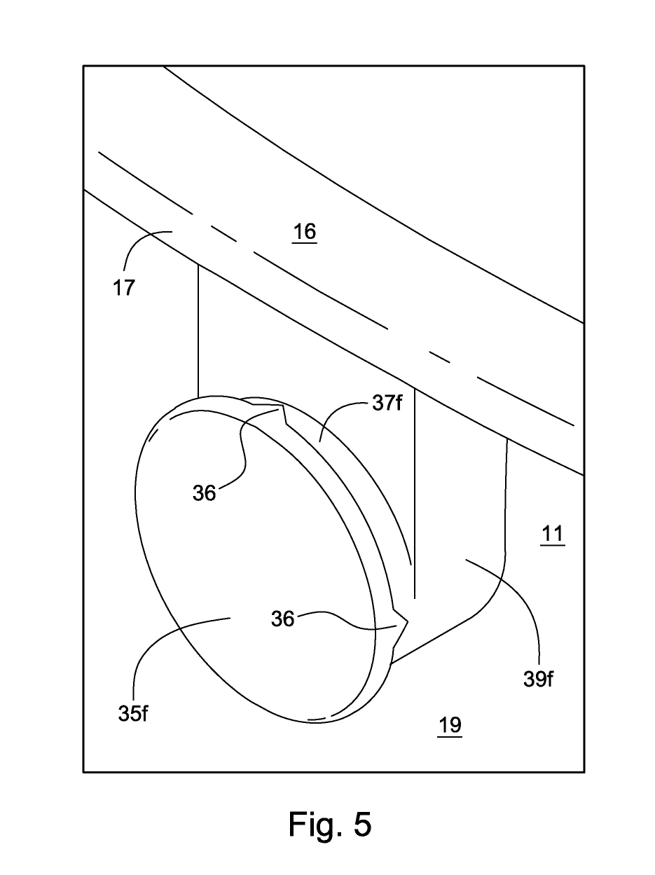

Now referring to FIG. 5, axle 37f is a cylindrical member that protrudes from bowl 11 and forms the rounded lower surface of axle base 39f. Axle base 39f extends upwardly to lip 17 with flat parallel surfaces formed tangentially to the diameter of axle 37f, but does not protrude from bowl 11 as far as axle 37f. The extra protrusion of axle 37f from axle base 39f (best shown in FIG. 6A) creates the circumferential surface that detents 42f and 43f hold and rotate around when colander 12 is being rotated with respect to bowl 11. Head 35f protrudes from axle base 39f and has a plurality of teeth 36 extending from head 35f toward bowl exterior wall 19.

FIG. 6 is a right lateral view of bowl 11 showing diametrically opposed heads 35f and 35r. FIG. 6A is an enlarged view of head 35f. Preferably, axle 37f, axle base 39f and head 35f are all integrally formed with each other and with bowl 11. Linear protrusion 45 is formed from smooth surface 46 along the upper bowl area near bowl rim 16 and has a lower surface substantially parallel to the base as opposed to following the curve of bowl rim 16. When colander 12 is attached to bowl 11, as is demonstrated in FIG. 1, linear protrusion 45 provides a surface for colander 12 to abut when in the closed position.

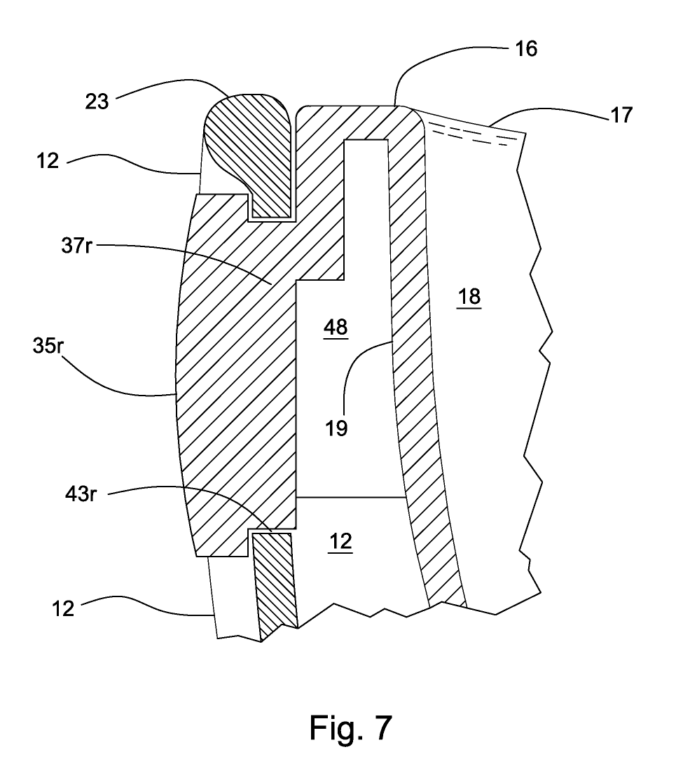

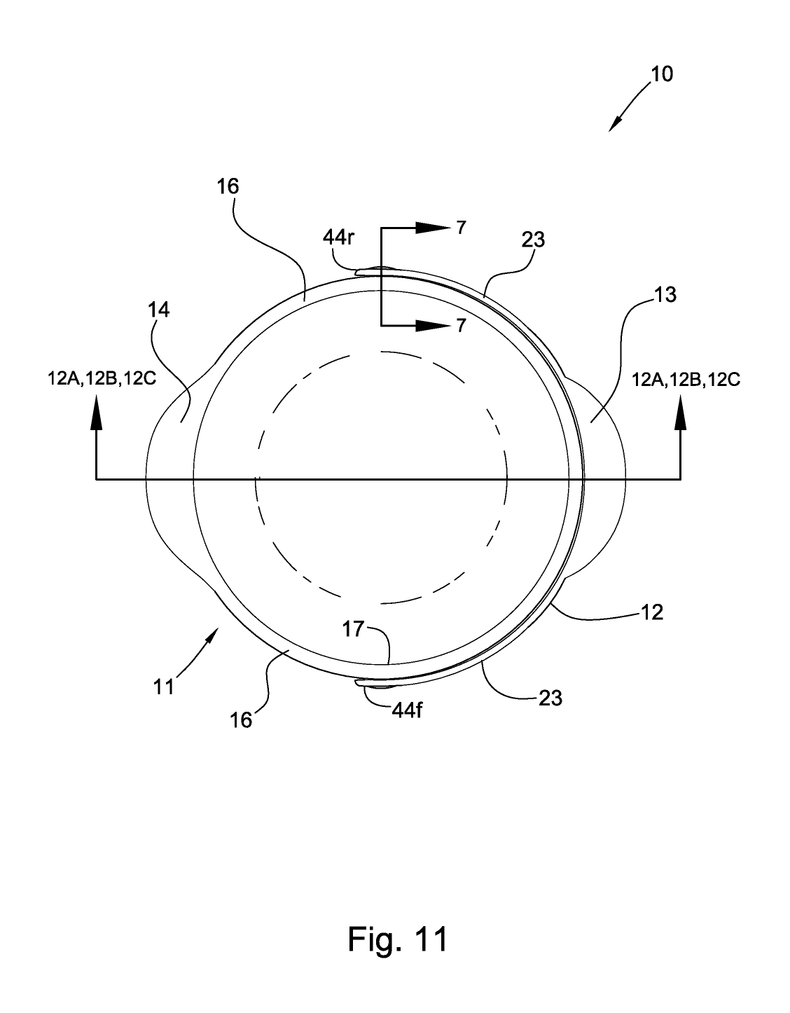

FIG. 7 is a fragmentary cross-sectional view of a section of the bowl/colander assembly, taken generally along line 7-7 in FIG. 11. This view shows hollow cavity 48 within axle base 39f resulting from the manufacturing process of making bowl 11.

FIG. 8 is a bottom view of bowl 11 showing the diametrically opposed heads 35f and 35r and hollow cavity 48 within axle base 39f. FIG. 8A is an enlarged view of head 35f and the hollow cavity within axle base 39f.

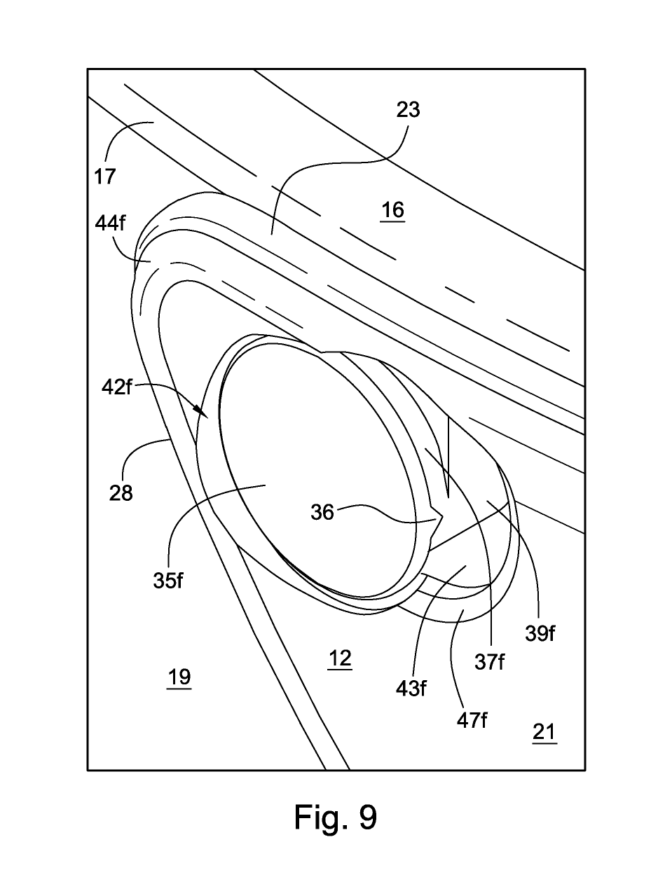

FIG. 9 shows how head 35f fits within the outer radius of colander beveled surface 47f, but acts as a physical barrier to the inner radius of beveled surface 47f so that colander 12 will not unintentionally disengage from axle 37f. Preferably, head 35f extends to create a flush surface with colander exterior wall 21 in order to keep the design sleek. Head 35f may be a disc or cylinder having a larger diameter than axle 37f, a conical frustum with its largest diameter smoothly forming into the smaller diameter of axle 37f, or mushroom shaped, but other geometries will serve this function as well. Teeth 36 protrude from head 35f toward axle base 39f in order to add friction to colander beveled surface 47f for stability. In an embodiment, colander 12 is removably secured to bowl 11 to further facilitate easy cleaning and versatility in storage and function. This is done by using resilient material, such as plastic, to make colander 12.

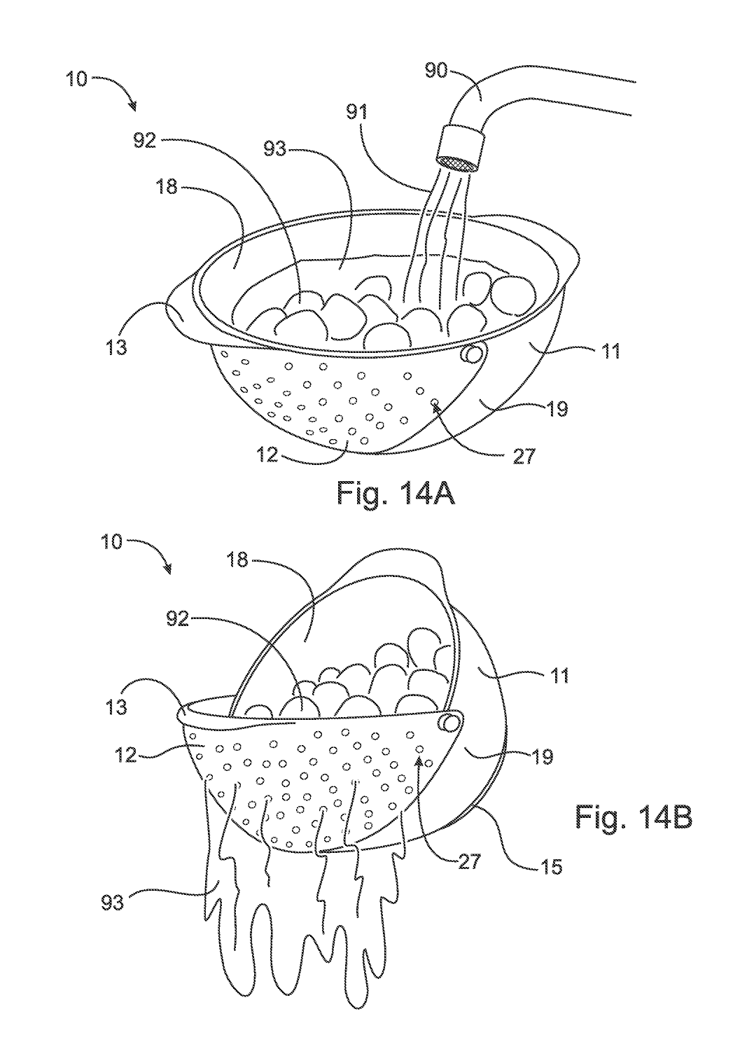

FIG. 10A shows assembly 10 in a locked closed position. This position corresponds to FIG. 4A (where locking detent 43f holds axle 37f), such that colander rim 23 (labeled in FIG. 2) and handle 13 rest under bowl lip 17. Lip 17 impedes the rotational movement of colander 12 with respect to bowl 11, thereby allowing the user to carry assembly 10 with both hands while not worrying about any unintentional rotation. When assembly 10 is in this position, it functions solely as a bowl and can be used for any of the food preparatory techniques such as cleaning, rinsing, mixing or anything that a bowl is known to be used for. As a functional example, FIG. 14A shows that running water 91 from spout 90 is retained in assembly 10 as cleaning water 93 for food material 92.

FIG. 12A is a cross-sectional view of the embodiment shown in FIG. 11 taken generally along line 12A-12A in FIG. 11, and is the corresponding cross-sectional view of the embodiment of FIG. 10A. In this view, linear protrusion 45 (labeled in FIG. 6) is visible spanning the gap between bowl 11 and colander 12 in the locked closed position in order to provide stability at the colander-bowl interface. Linear protrusion 45 is formed from smooth surface 46 (labeled in FIG. 6) along the upper bowl area and has a lower surface substantially parallel to the base as opposed to following the curve of bowl rim 16.

FIG. 10B shows assembly 10 in a transitioning closed position. This position corresponds to FIG. 4C (where transitioning detent 42f holds axle 370, such that the gap between colander 12 and bowl 11 (resulting from a larger radius spherical lune as described above) allows colander rim 23 to extend around bowl lip 17 and above bowl rim 16 into a transitioning open position. FIG. 12B is the corresponding cross-sectional view of the embodiment shown in FIG. 10B and the gap can be seen in FIG. 12B as compared to FIG. 12A.

FIG. 10C shows assembly 10 in a transitioning open position. Once colander 12 is in this open position, switching axle 37f from transitioning detent 42f into locking detent 43f will lock colander 12 into the open position. In the locked open position, assembly 10 functions as both a bowl and a colander. FIG. 14B shows cleaning water 93 can be drained by passing through apertures 27 while food materials 92 remain as contained material. After all cleaning water 92 is drained, the user can rotate assembly 10 from FIG. 14B so that the bowl is horizontally positioned and then switch axle 37f into transitioning detent 42f (as previously described with reference to FIGS. 4A-C) and rotate colander 12 into the closed position.

Assembly 10 is in an open position whenever colander 12 is rotated to the point that any of apertures 27 are above rim 16. The angular range that colander 12 can achieve relative to bowl 11 is dictated by its geometry. It is conceivable to one having ordinary skill in the art that colander 12 can have the geometry to be rotated above rim 16 such that when bowl 11 is rotated at substantially a right angle, the end position of colander 12 has substantially maintained the original pre-tilt horizontal position of bowl 11. This particular angular orientation optimizes the tilt angle for dispensing liquids while simultaneously preventing contained materials from falling out over either of rims 23 and 15.

FIG. 11 is a top view of the embodiment shown in FIG. 1 and it defines the cross-sectional plane 12A,12B,12C used in the description of the invention as illustrated in FIGS. 12A-C.

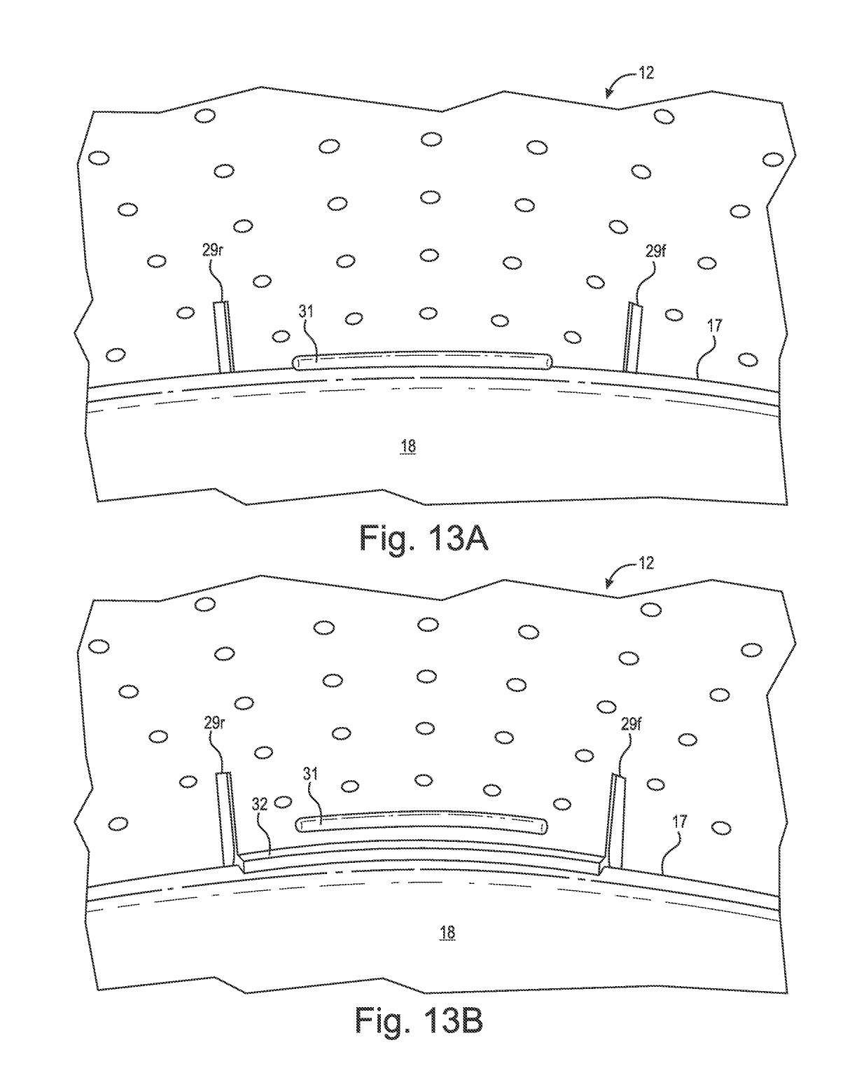

As shown in FIGS. 13A and 13B, first bumper 31 and second bumper 32 are configured between slits 29f and 29r to abut the top and bottom of bowl lip 17 in the locked open position as can be seen in FIG. 12C. Slits 29f and 29r extend upward from the bottom edge of colander 12. Preferably, bumper 32 spans the entire distance between slits 29f and 29r in order to decrease dripping between the interface between colander 12 and bowl 11 when in the locked open position, and to impede further rotational movement of colander 12 past bowl lip 17. While second bumper 32 abuts the bottom of lip 17, first bumper 31 abuts the top of lip 17 in order to keep colander 12 in the open position by impeding the downward swing of colander 12 that would otherwise result from gravity.

When in an open position, assembly 10 can easily transition into the extended open position shown in FIG. 10E with the aid of slits 29f and 29r and ridge 28 described in FIGS. 13A and 13B. As is demonstrated in FIG. 10D, the user disengages second bumper 32 from lip 17 by flexing the intervening colander material between slits 29f and 29r away from bowl 11. With the rotational movement of colander 12 no longer being impeded by bumper 32, assembly 10 can transition into the extended open position. The extended open position allows colander 12 to be freely washed while still being attached to bowl 11.

Referring back to FIG. 10A, bowl 11 has base 15 to provide a stable surface such that assembly 10 can stand on its own. Base 15 is a hollow cylindrical shell integrally formed with bowl 11 to decrease the chance of assembly 10 hydroplaning when set onto a wet surface. In a preferred embodiment, a rubber ring or other gripping material is securely inserted into a bottom annular valley in base 15 and protrudes further downwards than base 15 to provide a non-slip surface.

Handle 13 extends outwardly from colander 12 and handle 14 extends outwardly from bowl 11 for the user to grip while holding assembly 10. Handle 13 is configured to keep the user's hand out of the way of any material passing outwardly through any of the plurality of apertures 27 (labeled in FIG. 1) and, therefore, preferably extends from rim 23. However, it is conceivable to place handle 13 anywhere on colander 12 so long as none of the plurality of apertures 27 are above the handle. It is also preferable that handle 13 be integrally formed as a smooth continuance of the colander material from rim 23 functioning to further protect the user's hand by covering the fingers. This also has the benefit of allowing a manufacturer the option to create colander 12 by a molding process. It should be understood that handle 13 can be mounted, attached, connected or otherwise fixed to colander 12 and can be made from material other than the material used for the colander.

Handle 13 is not limited to the smooth gradual curving downwards in the lateral direction and the smooth gradual deviation outwardly from the curve created by rim 23 from vertex 44f to vertex 44r as can be seen in FIG. 11. While gradual curves and smooth surfaces provide a comfortable gripping experience, virtually any shape, texture and configuration can be used to help the user hold the handles easily. Some examples of variations include, but are not limited to, indentations, grooves, knurling, protrusions, an extra gripping member attached of a different material, and one or more holes for a finger or hand to hook through. Hanging loops or clips for easy storage can also be attached for any finger or hand holes.

Handles 13 and 14 are also used by the user to apply the torque required to pivot colander 12 above rim 16 of bowl 11. To this extent, handles 13 and 14 are preferably diametrically opposed from one another and perpendicular to heads 35f and 35r that lie substantially on the same horizontal plane as depicted in FIG. 10A. Handles 13 and 14 can be angularly displaced from one another as long as handle 14 extends from bowl 11 and handle 13 extends from colander 12. Handle 14 should be substantially similar in shape to handle 13, and it is preferable that handle 14 and handle 13 are identical in shape.

Colander 12 has a plurality of apertures 27 (labeled in FIG. 1) for allowing unwanted contained material to pass through when assembly 10 is in an open position. While apertures 27 are preferably all round in shape, the same size, and small enough to keep morsels of food from passing through, other shapes and sizes are possible without departing from the essence of the present invention. For example, stars or crosses can be used in order to allow more water to pass through while still retaining small food items. The sizes of apertures 27 need not be uniform and a possible arrangement includes using larger sizes near rim 23 to facilitate drainage while at the same time using smaller sizes farther away from rim 23 to be used in aiding the retention of smaller food particles.

Colander 12 should be made of a material that allows some flexibility and is dishwasher safe such as plastic. Bowl 11 is preferably made from the same material as the colander, but other materials known to be used for bowls can be used. Examples include, but are not limited to, stainless steel, ceramic, glass, and wood.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention as claimed.

### LIST OF REFERENCE NUMERALS

10 colander-bowl assembly
11 bowl
12 colander
13 handle member
14 handle member
15 base
16 bowl rim
17 bowl lip
19 bowl exterior wall
21 colander exterior wall
22 colander interior wall
23 colander rim
27 apertures
28 ridge
29 slit
31 first tab
32 second tab
35 head
36 teeth
37 axle
39 axle base
42 transition detent
43 locking detent
44 colander vertex
45 linear protrusion
46 curved surface
47 beveled surface
48 hollow cavity
52 transition detent center point
53 locking detent center point
54 point
55 point
90 faucet
91 running water
92 food material
93 cleaning water

What is claimed is:

1. A colander-bowl assembly, comprising:
a bowl, having a rim and having a first handle member extending outwardly from said rim; and,
a colander pivotally secured to said bowl, said colander having a rim and also having a second handle member extending outwardly from said colander rim;
wherein said colander rotates exterior to said bowl.

2. The colander-bowl assembly recited in claim 1 wherein said first and second handle members are substantially similar in shape.

3. The colander-bowl assembly recited in claim 1 wherein said first and second handle members are identical in shape.

4. The colander-bowl assembly recited in claim 1 wherein said first and second handle members are diametrically opposed from one another.

5. The colander-bowl assembly recited in claim 1 wherein said bowl further includes a detent operatively arranged to lock said colander in place in an open position.

6. The colander-bowl assembly recited in claim 1 wherein said bowl further includes a detent operatively arranged to lock said colander in place in a closed position.

7. The colander-bowl assembly recited in claim 1 wherein said colander is pivotally secured to an exterior wall of said bowl, and arranged to rotate exterior to said bowl.

8. The colander-bowl assembly recited in claim 7 wherein said exterior wall of said bowl is of a first shape, and said colander has an interior wall arranged to slidingly engage said bowl exterior wall, where said colander interior wall has a shape substantially similar to said first shape.

9. The colander-bowl assembly recited in claim 1 wherein said bowl further comprises a protrusion extending outwardly from the bowl and under said rim, arranged opposite said first handle member.

10. The colander-bowl assembly recited in claim 1 wherein said colander further comprises a first bumper extending inwardly from a rim of said colander and positioned on an opposite side of said colander than said second handle, wherein said bumper and said bowl rim are arranged to contact one another and limit rotation of said colander relative to said bowl.

11. The colander-bowl assembly recited in claim 10 wherein said colander further comprises a slit extending upwardly from the bottom of said colander, wherein said slit is configured to facilitate bending said colander outwardly from said bowl such that said bumper disengages said bowl protrusion.

12. The colander-bowl assembly recited in claim 10 wherein said colander further comprises a second bumper extending inwardly, wherein said first and second bumpers are arranged to abut the top and bottom of said bowl rim limit rotation of said colander relative to said bowl.

13. The colander-bowl assembly recited in claim 1 wherein said bowl is a concave member having an open top end.

14. The colander-bowl assembly recited in claim 1 wherein said bowl is a hollow semi-sphere.

15. The colander-bowl assembly recited in claim 1 wherein said colander is a concave member having an octosphere shape.

16. A colander-bowl assembly, comprising:
a bowl, having an exterior and a secure means protruding outwardly from said exterior on diametrically opposing sides of said bowl; and,
a colander secured to said secure means of said bowl.

17. The colander-bowl assembly recited in claim 16 wherein said colander is removably secured to said secure means.
